(19) United States
(12) Patent Application Publication
(10) Pub. No.: US 2006/0246804 A1
(43) Pub. Date: Nov. 2, 2006

(54) Elastomeric materials

(76) Inventors: Oomman Painumoottil Thomas, Alpharetta, GA (US); Melpo Lambidonis, Cumming, GA (US); Howard Martin Welch, Woodstock, GA (US)

Correspondence Address: KIMBERLY-CLARK WORLDWIDE, INC., 401 NORTH LAKE STREET, NEENAH, WI, 54956, US

(21) Appl. No.: 11/119,503

(22) Filed: Apr. 29, 2005

(51) Int. Cl. D04H 13/00; B32B 5/26; D04H 1/56; D04H 1/00

(52) U.S. Cl. 442/328; 442/381; 442/415; 442/400; 442/382

(57) ABSTRACT

The present invention is directed to elastic webs, such as elastic films and elastomeric fibrous meltblown or spunbond webs which may include elastomeric fibers and/or elastomeric continuous filaments. The elastic webs include an elastomeric block copolymer and an amorphous polyolefin plastomer wax. The elastic webs may include a tackifier, but desirably they do not. The elastic webs of the present invention may display hysteresis values and/or immediate set values upon elongation and retraction less than the hysteresis values and immediate set values of previously known elastic webs of similar basis weight. The elastic webs may display tension values upon elongation less than tension values displayed by previously known elastic webs of similar basis weight. The present invention is also directed to elastic laminate structures comprising at least one layer of an elastic web adhesively bonded to one or more other webs, such as, for instance a woven or nonwoven web.

### BACKGROUND OF THE INVENTION

Elastomeric materials have been used in the past in countless different applications. For instance, waist bands, leg bands, feminine care products, adult care products, and diapers employ elastic components in order to supply such articles with elastic properties and a better fit. In many applications, elastic materials are bonded to one or more other layers in order to form laminated structures in these and other applications.

In U.S. Pat. No. 4,657,802 to Morman, a process for producing a composite nonwoven elastic web including a nonwoven elastic web joined to a fibrous nonwoven gathered web is disclosed. The process includes the steps of (a) providing a nonwoven elastic web having a relaxed unbiased length and a stretched, biased length; (b) stretching the nonwoven elastic web to its stretched, biased length; (c) forming a fibrous nonwoven gatherable web directly upon a surface of the nonwoven elastic web while maintaining the nonwoven elastic web at its stretched, biased length; (d) forming a composite nonwoven elastic web by joining the fibrous nonwoven gatherable web to the nonwoven elastic web while continuing to maintain the nonwoven elastic web at its stretched length; and (e) relaxing the nonwoven elastic web to its relaxed length to gather the fibrous nonwoven gatherable web. The joining of the fibrous nonwoven gatherable web to the nonwoven web is achieved by heat-bonding or sonic bonding to fuse the two webs to each other.

In U.S. Pat. No. 4,720,415 to Vander Wielen, et al., a method of producing a composite elastic material is disclosed which comprises stretching an elastic web to elongate it, for example elongating a nonwoven web of meltblown elastomeric fibers, and bonding the elongated web to at least one gatherable web, such as a spunbonded polyester fiber material, under conditions which soften at least a portion of the elastic web to form the bonded composite web of elastic material.

There remains a need in the art for elastic materials which display good low tension elastic characteristics including improved hysteresis performance.

### SUMMARY

The present invention is directed to elastic webs and laminate structures which include the elastic webs.

The elastic webs of the present invention comprise one or more elastomeric block copolymers. The elastomeric block copolymers include at least one thermoplastic block which includes a styrenic moiety and at least one elastomeric polymer block which may be a conjugated diene, a lower alkene polymer, or their saturated equivalents. For example, the elastomeric block copolymer may be a multi-block copolymer such as, for example, a di-block copolymer, a tri-block copolymer, or a tetra-block copolymer. In various embodiments, the elastomeric polymer block(s) may include an ethylene-propylene block, an ethylene-butylene block, or combinations of elastomeric polymer blocks. The elastic web may be a fibrous nonwoven web, such as a meltblown web, a spunbond web, or a coform web, or may be an elastic film. Furthermore, in one embodiment, the elastic web may include elastic filaments.

In addition to the elastomeric block copolymer, the elastic webs of the present invention include up to about 50% by weight of an amorphous polyolefin plastomer wax. For example, the elastic web may include between about 5% and about 40% by weight of an amorphous polyolefin plastomer wax. In one embodiment, the amorphous polyolefin plastomer wax may be a polyethylene wax, a polypropylene wax, a polybutene wax, or a mixture of these waxes. In one embodiment, the amorphous polyolefin plastomer wax may include a copolymer.

In one embodiment, the elastic web is substantially free of a tackifier.

In one embodiment, the elastic web of the present invention may have a basis weight of less than about 12 gsm and may display 450 grams-force tension when elongated by about 50% of its resting length.

The present invention is also directed to elastic laminate structures which include the elastic web as a layer of the laminate structure. For example, the laminate structures may include at least two, but optionally more, layers. In general, adjacent layers of the laminate structure may be adhesively secured together. In one embodiment, adjacent layers of the web may be adhesively secured together with a spray adhesive which is not a hot melt adhesive, such that added heat is not required to bond the layers of the laminate together.

The second web of the laminate structure may, in one embodiment, be a nonwoven web. For example, the second web may be a meltblown or spunbond web and may comprise polyolefin fibers. For instance, the second web may be a polyolefin fibrous web comprising polyethylene and/or polypropylene fibers. In one embodiment, the second web may comprise bicomponent polyolefin fibers.

In one embodiment of the present invention, the amorphous polyolefin plastomer wax in the elastic web and the polyolefin fibers in the adjacent web of the laminate structure may comprise the same polyolefin.

In general, the elastic laminate structure may be either a stretch-bonded laminate or a neck-bonded laminate.

The present invention is also directed to personal care products which may include the elastic laminate structures. For example, the personal care products of the present invention may include disposable elastic garments such as incontinence garments, disposable diapers, and disposable training pants. Other personal care products formed including the disclosed laminate structure may include protective covers, feminine hygiene pads, incontinence control pads, and the like.

### BRIEF DESCRIPTION OF THE FIGURES

A full and enabling disclosure of the present invention, including the best mode thereof to one of ordinary skill in the art, is set forth more particularly in the remainder of the specification, including reference to the accompanying figures in which:

FIG. 1 is a perspective schematic view illustrating one embodiment of a process for forming a nonwoven elastomeric web in accordance with the present invention;

FIG. 2 is a perspective schematic view illustrating an exemplary process for forming an anisotropic elastic fibrous web according to the present invention;

FIG. 3 is a perspective schematic view illustrating an alternative exemplary process for forming an anisotropic elastic fibrous web according to the present invention;

FIG. 4 is a schematic drawing illustrating an embodiment of a process for combining the layers of the composite laminate construction of the present invention;

FIG. 5 is a schematic drawing illustrating a personal care product utilizing a nonwoven elastomeric web made in accordance with the invention; and

FIG. 6 is a graph depicting normalized load as a function of elongation for films produced from compositions of the present invention.

Repeat use of reference characters in the present specification and drawings is intended to represent same or analogous features or elements of the present invention.

### DETAILED DESCRIPTION OF THE INVENTION

Reference will now be made in detail to various embodiments of the invention, one or more examples of which are set forth below. Each embodiment is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention cover such modifications and variations as come within the scope of the appended claims and their equivalents.

The present invention is directed to improved elastic materials. More specifically, the present invention is directed to low hysteresis elastic webs, such as, for example, elastic films and elastomeric fibrous webs. Elastomeric fibrous webs of the present invention may include elastic meltblown or spunbond fibers and/or filaments. The low hysteresis elastic webs of the present invention may display excellent mechanical characteristics. For example, in certain embodiments, the low hysteresis elastic webs of the present invention may display a surprising combination of tension values upon elongation and retraction.

The present invention is also directed to elastic laminate structures which include the disclosed elastic webs as at least one layer of the laminate structure. More specifically, the elastic laminate structures of the present invention comprise at least one layer of an elastic web according to the present disclosure adhesively bonded to one or more other webs, such as, for instance a woven or nonwoven web so as to form an elastic laminate structure. The elastic laminate structures made in accordance with the invention have shown remarkably good uniformity, hand, bulk, strength and elastic properties.

A wide variety of elastomeric materials may be included in the formulation used to form the elastic webs. As used herein and in the claims, the terms “elastic” and “elastomeric” have their usual broad meanings. However, for purposes of this invention, “elastic” may be conveniently defined as follows: A material is elastic if it is stretchable to an elongation of at least about 25 percent of its relaxed length, i.e., can be stretched to at least about one and one-quarter times its relaxed length, and upon release of the stretching force will recover at least about 40 percent of the elongation, i.e., will, in the case of 25% elongation, contract to an elongation of not more than about 15%. For example, a 100 centimeter length of material will, under the foregoing definition, be deemed to be elastic if it can be stretched to a length of at least about 125 centimeters and if, upon release of the stretching force, it contracts, in the case of being stretched to 125 cm, to a length of not more than about 115 centimeters. Of course, many elastic materials used in the practice of the invention can be stretched to elongations considerably in excess of 25% of their relaxed length, and many, upon release of the stretching force, will recover to their original relaxed length or very close thereto.

Elastic webs of the invention include both elastic films and nonwoven fibrous elastic webs. Nonwoven fibrous elastic webs include fibrous webs formed of elastomeric meltblown or spunbond fibers or filaments, as well as mixtures of elastomeric filaments and fibers. In one embodiment, meltblown and spunbond elastomeric fibrous webs may comprise “microfibers”, which is herein defined to include fibers of a diameter not greater than about 100 microns, e.g., fibers of from about 1 to 50 microns in diameter, such as those which may be obtained by either the meltblowing or spunbonding processes.

As used herein “meltblown” microfibers are defined as small diameter fibers, usually of a diameter not greater than about 100 microns, made by extruding a molten thermoplastic material as molten threads through a plurality of orifices into a high velocity gas (e.g., air) stream which may entrain the extruded threads at their point of emergence from the orifices and may attenuate the threads of molten thermoplastic material to reduce the diameter thereof. The gas stream-borne fibers then being deposited upon a collecting screen to form a coherent web of randomly dispersed fibers. Such a process is disclosed, for example, in U.S. Pat. No. 3,849,241 to Butin, et al., which is herein incorporated by reference thereto as to all relevant material.

As used herein, the term “spunbond fibers” refers to small diameter fibers of molecularly oriented polymeric material. Spunbond fibers may be formed by extruding molten thermoplastic material as filaments from a plurality of fine, usually circular capillaries of a spinneret with the diameter of the extruded filaments then being rapidly reduced as in, for example, U.S. Pat. No. 4,340,563 to Appel, et al., U.S. Pat. No. 3,692,618 to Dorschner, et al., U.S. Pat. No. 3,802,817 to Matsuki, et al., U.S. Pat. Nos. 3,338,992 and 3,341,394 to Kinney, U.S. Pat. No. 3,502,763 to Hartman, U.S. Pat. No. 3,542,615 to Dobo et al., and U.S. Pat. No. 5,382,400 to Pike, et al. Spunbond fibers are generally not tacky when they are deposited onto a collecting surface and are generally continuous. Spunbond fibers are often about 10 microns or greater in diameter. However, the fine fiber spunbond webs (have an average fiber diameter less than about 10 microns) may be achieved by various methods including, but not limited to, those described in commonly assigned U.S. Pat. No. 6,200,669 to Marmon, et al., and U.S. Pat. No. 5,759,926 to Pike, et al., each is hereby incorporated by reference in its entirety.

The meltblown or spunbond fibers of the present invention are not limited to microfibers, however. In some embodiments, larger fibers may be formed of the elastic materials. In general, any suitable fiber sizes may be utilized in the present invention, including, for example, fibers having an average diameter up to and, in some embodiments, greater than about 100 microns in diameter.

The elastic materials of the present invention may also include elastomeric filaments which may form a nonwoven fibrous elastic web. The inclusion of continuous filaments in a fibrous web may improve the tenacity of the fibrous web. For example, in one embodiment, elastomeric continuous filaments may be included in an elastic web and may extend along the length (i.e. machine direction) of the fibrous web. Elastomeric filaments of the present invention may generally have an average diameter in the range from about 50 to about 800 microns, for example, from about 100 to about 200 microns. In one embodiment, a layer of substantially parallel continuous filaments formed from the presently disclosed elastic formulation may be included in a nonwoven fibrous web wherein the filaments are formed at a density per inch of width of material ranging from about 10 to about 120 filaments per inch width of material. Examples of elastic webs including substantially parallel elastomeric continuous filaments such as may be utilized in the present invention are described in U.S. Pat. No. 5,385,775 to Wright, which is herein incorporated by reference thereto as to all relevant matter.

A nonwoven fibrous elastic web may also comprise a composite material in that it may comprise two or more individual coherent webs or it may comprise one or more webs individually comprised of a mixture of elastic fibers and/or filaments according to the present invention with other discrete particles, for example other fibers. For example, a nonwoven fibrous elastic web may be a coform web. As used herein, the term “coform nonwoven web” or “coform material” means composite materials comprising a mixture or stabilized matrix of thermoplastic filaments and at least one additional material, usually called the “second material” or the “secondary material.” As an example, coform materials may be made by a process in which at least one meltblown die head is arranged near a chute through which the second material is added to the web while it is forming. The second material may be, for example, an absorbent materials such as fibrous organic materials such as woody and non-woody cellulosic fibers, including regenerated fibers such as cotton, rayon, recycled paper, pulp fluff; superabsorbent materials such as superabsorbent particles and fibers; inorganic absorbent materials and treated polymeric staple fibers and the like; or a non-absorbent material, such as non-absorbent staple fibers or non-absorbent particles. Exemplary coform materials are disclosed in commonly assigned U.S. Pat. No. 5,350,624 to Georger, et al., U.S. Pat. No. 4,100,324 to Anderson, et al., and U.S. Pat. No. 4,818,464 to Lau, et al., the entire contents of each is hereby incorporated by reference.

In general, the elastic materials of the present invention are formed from a thermoplastic elastic formulation including elastomeric block copolymers. For example, multi-block copolymers including, for instance, di-block copolymers having the general formula A-B, tri-block copolymers having the general formula A-B-A′, or tetrablock copolymers having the general formula A-B-A′-B′ or A-B-B′-A′, where A and A′ are the same or different, and B and B′ are the same or different may be used. A and A′ each being a thermoplastic polymer block which contains a styrenic moiety and B and B′ being an elastomeric polymer block such as a conjugated diene or a lower alkene polymer or their saturated equivalents. In general, the elastomeric block copolymers of the present invention may contain up to about 35% styrene. For example, the block copolymers may contain from about 15% to about 30% styrene. In one embodiment, block copolymers such as those available from KRATON Polymers of Houston, Texas under the brand name KRATON® or those available from Dexco Polymers of Houston, Tex. under the trade name VECTOR™ may be used. In these block copolymers, the polystyrene is a thermoplastic with a glass transition temperature above room temperature (T_{g} about 75° C.) and the elastomeric block is a rubber with a glass transition temperature well below room temperature. As such, the polystyrene and the elastomeric block are thermodynamically incompatible. Because of this incompatibility, the polystyrene blocks, being in minor proportion in the elastomeric polymer, may unite to form polystyrene domains that may be uniformly distributed throughout the elastomeric material. This creates a stable matrix similar to that of vulcanized polybutadiene, natural rubber, or styrene-butadiene rubber.

As used herein the term “styrenic moiety” is defined as a monomeric unit represented by the formula:

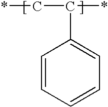

In one embodiment, the A and A′ blocks may be selected from the group including polystyrene and polystyrene homologs such as poly(alpha-methylstyrene).

In one embodiment, the B and B′ blocks may be polyisoprene, poly(ethylene-propylene), polyethylene, polybutadiene, or poly(ethylene-butylene).

In one embodiment of the elastic material, elastomeric block copolymers may be utilized having a saturated or essentially saturated poly(ethylene-propylene) elastomeric block B and/or B′ segments having the following general formula: 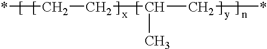
where x, y, and n are positive integers, and polystyrene A and/or A′ segments represented by the formula: 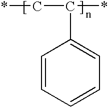
where n is a positive integer. Such elastomeric block copolymers are sometimes referred to as S-EP-S (polystyrene/poly(ethylene-propylene)/polystyrene) tri-block copolymers or S-EP-S-EP (polystyrene/poly(ethylene-propylene)/polystyrene/poly(ethylene-propylene)) tetra-block copolymers. Specific embodiments of these block copolymers are available under the trademark KRATON® G, for example, KRATON® G-1701, KRATON® G-1702 and KRATON® G-1730 from KRATON Polymers of Houston, Tex. KRATON® G-1701 has a block styrene percent mass of 37%, a Shore A hardness of 64, and a solution viscosity of 50 Pa-s at 25% mass in toluene at 25° C. KRATON® G-1702 has a block styrene percent mass of 28%, a Shore A hardness of 41, and a solution viscosity of 50 Pa-s at 25% mass in toluene at 25° C. KRATON® G-1730 has a block styrene percent mass of 21% and a Shore A hardness of 66. In one embodiment, these exemplary ethylene-propylene block copolymers may also be combined with radial S-EP-S block copolymers, such as those designated G-1750M and G-1765 available from the KRATON Polymers Company. 20 In another embodiment, block copolymers including poly(ethylene-propylene) B segments and polyethylene B′ segments may be utilized represented by the formula: 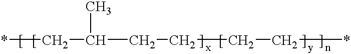
where x, y and n are positive integers, and polystyrene A and A′ blocks as defined above may be used. These block copolymers are sometimes referred to as S-E-EP-S (polystyrene/polyethylene/poly(ethylene-propylene)/polystyrene) block copolymers, and are available under the trademark SEPTON 4033, SEPTON 4044, SEPTON 4055, and SEPTON 4077 from the Septon Company of America of Pasadena, Tex. SEPTON 4033 has a styrene content of about 30 wt %, a Shore A hardness of about 76, and a 10 wt % solution viscosity of 50 mpa-s. SEPTON 4044 has a styrene content of about 32 wt %, and a 10 wt % solution viscosity of 460 mPa-s. SEPTON 4055 has a styrene content of about 30 wt %, and a 10 wt % solution viscosity of 5800 mPa-s. SEPTON 4077 has a styrene content of about 30 wt %, and a 5 wt % solution viscosity of 300 mpa-s.

In another embodiment, block copolymers including poly(ethylene-butylene) B and/or B′ segments may be utilized represented by the formula: 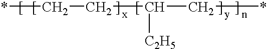
where x, y and n are positive integers, and polystyrene A and A′ blocks as defined above may be used. These block copolymers are sometimes referred to as S-EB-S (polystyrene/poly(ethylene-butylene)/polystyrene) tri-block copolymers, and are available under the trademark KRATON G, for example, KRATON G-1650, KRATON G-1652 and KRATON G-1657M from KRATON Polymers of Houston, Tex. KRATON G-1 650 has a block styrene percent mass of 30%, a Shore A hardness of 72, and a solution viscosity of 8 Pa-s at 25% mass in toluene at 25° C. KRATON G-1652 has a block styrene percent mass of 30%, a Shore A hardness of 75, and a solution viscosity of 1.35 Pa-s at 25% mass in toluene at 25° C. KRATON G-1657M has a block styrene percent mass of 13% and a Shore A hardness of 47.

Other elastomeric resins which may be utilized in forming the elastic materials of the present invention include block copolymers where A and A′ are polystyrene blocks, as defined above, and B and/or B′ is a polybutadiene block represented by the following formula: 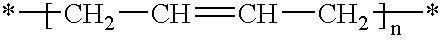
where n is a positive integer. This material is sometimes referred to as a S-B-S tri-block copolymer and is available from KRATON Polymers of Houston, Tex. under the trade designation KRATON D; for example, KRATON D-1101, KRATON D-1102 and KRATON D-1116. According to KRATON Polymers, KRATON D-1101 has a block styrene percent mass of 31%, a Shore A hardness of 69, and a solution viscosity of 4 Pa-s at 25% mass in toluene at 25° C. KRATON D-1102 has a block styrene percent mass of 28% and a Shore A hardness of 66. KRATON D-1116 has a block styrene percent mass of 23%, a Shore A hardness of 63, and a solution viscosity of 9 Pa-s at 25% mass in toluene at 25° C. These block copolymers are available as porous pellets and have a specific gravity of 0.94.

Another S-B-S block copolymer suitable for use in the elastic materials of the present invention is commercially available under the trade designation SOLPRENE® and CALPRENE® from the Dynasol Company of Houston, Tex.

Other elastomeric resins which may be utilized to form the elastic webs of the present invention are block copolymers where A and A′ are polystyrene blocks, as defined above, and B and/or B′ are polyisoprene blocks where the polyisoprene block may be represented by the formula: 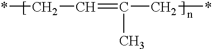
where n is a positive integer. These block copolymers are sometimes referred to as S-I-S tri-block copolymers and are also available from KRATON Polymers under the trade designation KRATON D, for example, KRATON D-1107, KRATON D-1111, KRATON D-1112P and KRATON D-1117. KRATON D-1107 has a block styrene percent mass of 15%, a Shore A hardness of 32, and a solution viscosity of 1.6 Pa-s at 25% mass in toluene at 25° C. KRATON D-1111 has a block styrene percent mass of 22%, a Shore A hardness of 45, and a solution viscosity of 1.2 Pa-s at 25% mass in toluene at 25° C. KRATON D-1112P has a block styrene percent mass of 15%, a Shore A hardness of 25, and a solution viscosity of 0.9 Pa-s at 25% mass in toluene at 25° C. KRATON D-1117 has a block styrene percent mass of 17%, a Shore A hardness of 32, and a solution viscosity of 0.7 Pa-s at 25% mass in toluene at 25° C. The D-1111 grade is available as a porous pellet having a specific gravity of 0.93. The D-1107, D-1112 and D-1117 block copolymers are available as pellets having specific gravities of 0.92.

Other exemplary elastomeric polymers which may be utilized to form the elastic webs of the present invention are described in U.S. Pat. No. 6,323,389 to Thomas et al., the entire contents of which are incorporated herein by reference.

These exemplary block copolymers are not believed to contain plasticizer oils although they are commercially available in compounded form.

It should be understood that the elastic materials of the present invention are not limited to the foregoing list of exemplary elastomeric block copolymers and other suitable elastomeric block copolymers may alternatively be utilized in the disclosed elastic webs.

In accordance with the present invention, in addition to the elastomeric block copolymers, the thermoplastic elastic formulation used to form the elastic webs includes a low molecular weight polyolefin polymer or oligomer wax having very low levels of crystallinity. Specifically, an amorphous polyolefin plastomer wax may be utilized which is miscible with the elastomeric block copolymer at processing temperatures. This will have the beneficial effect of improving processability of the elastomeric block copolymer by lowering the viscosity of the thermoplastic elastic formulation at processing conditions.

Additional benefits may be gained by the addition of the amorphous polyolefin plastomer wax to the elastic formulation, as well. For example, it has been discovered that at use conditions, the presence of the amorphous polyolefin plastomer wax in the thermoplastic elastic formulation may provide an elastic web having decreased level of hysteresis upon extension and retraction of the elastic web. For purposes of this disclosure, “hysteresis” is herein defined to be the difference between the area under the normalized load extension curve and the area under the normalized load retraction obtained from a load-strain cycle test, the quantity being expressed as a percentage of the area under the normalized load extension curve. Desirably, the elastic formulation of the present invention may provide an elastic web or film exhibiting hysteresis values ranging from about 5% to about 35% in a 300% elongation cycle test, more desirably from about 25% to about 30%, and even more desirably from about 26% to about 28%. Desirably, the elastic formulation of the present invention may provide an elastic web or film exhibiting hysteresis values ranging from about 5% to about 45% in a 500% elongation cycle test, more desirably from about 30% to about 45%, and even more desirably from about 34% to about 40%.

Additionally, the presence of the amorphous polyolefin plastomer wax in the thermoplastic elastic formulation may provide an elastic web having decreased level of immediate set after extension and retraction of the elastic web. For purposes of this disclosure, “immediate set” is herein defined to be the increase in the length of a sample after extension and retraction of the sample in a cycle tension test. Immediate set may be expressed as a percentage of the initial sample length. Desirably, the elastic formulation of the present invention may provide an elastic web or film exhibiting immediate set values ranging from about 5% to about 25% in a 300% elongation cycle test, more desirably from about 15% to about 25%, and even more desirably from about 17% to about 23%. Desirably, the elastic formulation of the present invention may provide an elastic web or film exhibiting immediate set values ranging from about 5% to about 50% in a 500% elongation cycle test, more desirably from about 30% to about 40%, and even more desirably from about 31% to about 39%.

The improvement in elastic properties is believed to be due to the low crystallinity of the amorphous polyolefin plastomer wax as well as the compatibility between the amorphous polyolefin plastomer wax and the elastomeric material, i.e., the amorphous polyolefin plastomer wax will not interfere with the ability of the elastomeric material to act as an elastomer. In addition, it is believed that the amorphous polyolefin plastomer wax molecules do not reinforce the elastomeric matrix of the material at use conditions, thus resulting in reduced tension being required to elongate the elastic material. Because tensions are reduced, it is possible to utilize higher molecular weight and better performing elastomers to further improve the characteristics of the material. In sum, the addition of the amorphous polyolefin plastomer wax to the elastomeric formulation may provide reduced hysteresis and tension in the elastic web formed by the process as a function of elongation and composition.

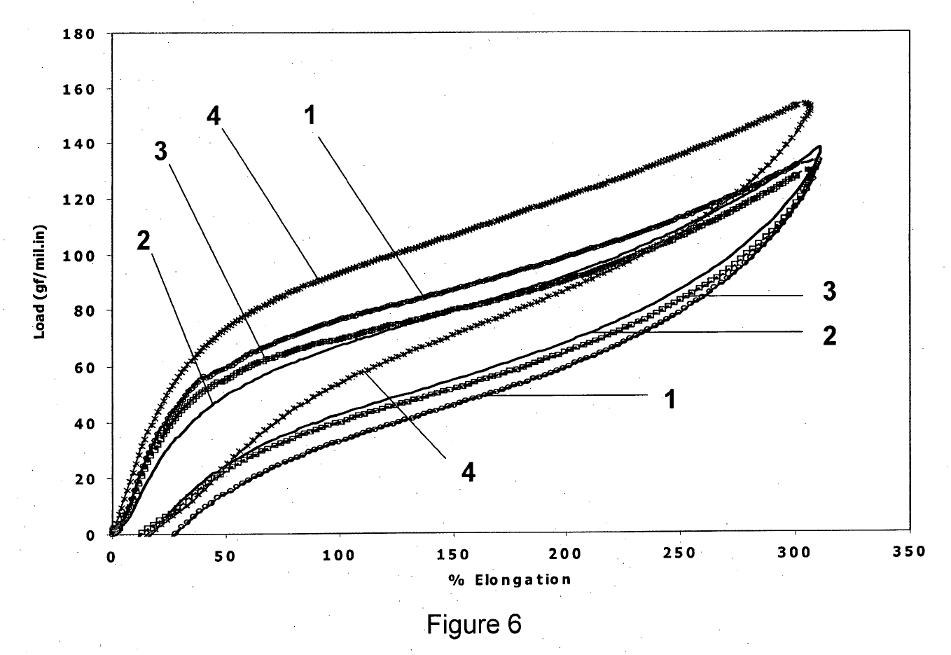

FIG. 6, which will be further described herein, illustrates the improved hysteresis and immediate set for materials formed according to the present invention compared to materials having crystallized and/or crystallizable wax. As can be seen, use of amorphous polyolefin wax added to the formulation translates to a reduction in hysteresis and a reduction in immediate set. Reduction in the quantity of the amorphous wax results in an increase in the load at a certain elongation. The maximum fraction of amorphous polyolefin wax in the formulation is generally about 50% by weight. Desirably, the amorphous polyolefin plastomer wax has a degree of crystallinity between about 3% and about 20%, more desirably between about 10% and about 20%, even more desirably between about 16% and about 19%, or even more desirably between about 15.8% and about 18.3%.

The modulus of the elastic web may generally be described as follows:
Eₘ=ΦₚEₚ+Φ_{w}E_{w}
wherein: Eₘ is the modulus of the elastic material
   Eₚ is the modulus of the polymer
   E_{w} is the modulus of the amorphous polyolefin plastomer wax
   Φₚ is the volume fraction of the polymer in the formulation
   Φ_{w} is the volume fraction of the amorphous polyolefin plastomer wax in the formulation

Thus, when the amorphous wax has a modulus less than the elastomer, decreases in the quantity of wax will cause the load at certain elongation to rise in the blend.

In one embodiment, the amorphous plastomer wax, or elastomeric polyolefin wax, may have a density of less than about 0.885 g/cm³. Although any amorphous elastomeric polyolefin wax may be utilized, a narrow molecular weight distribution amorphous polyolefin such as a metallocene-catalyzed polyethylene, a metallocene-catalyzed polypropylene, other metallocene-catalyzed copolymers or homopolymers of alphaolefins, or, other single-site catalyzed amorphous polyolefins and constrained geometry catalyzed polyolefins may be desirable in certain embodiments. Desirably, such elastomeric polyolefins will have a density of between about 0.860 g/cm³ and about 0.880 g/cm³ and may, more desirably, have a density of between about 0.870 g/cm³ and about 0.874 g/cm³.

These amorphous plastomers may utilize, for example, metallocene catalyst technology which permits precise control of a comonomer incorporated into the polyethylene polymer and of molecular weight distribution. A metallocene catalyst is a metal derivative of cyclopentadiene and the catalysis of the polymer can be described as a homogeneous single site or constrained geometry catalysis. A metallocene is a neutral, ancillary ligand stabilized transition metal complex and can have the following general formula:

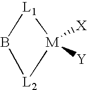

wherein:

L₁ is a cyclopentadienyl or substituted cyclopentadienyl moiety bonded to the metal through η-5 bonding

L₂ is an organic moiety, which may or may not be a cyclopentadienyl moiety, strongly bonded to the metal which remains bonded to the metal during polymerization

B is an optional bridging group that restricts the movement of L₁ and L₂ and that modifies the angle between L₁ and L₂

M is a metal such as, for instance, titanium or zirconium

X and Y are halides or other organic moieties, such as methyl groups

The metallocene complex acts as a catalyst that initiates polymerization of a monomer to form a polymer. For instance, in order to form a metallocene-catalyzed polymer, a liquid monomer, such as ethylene, is combined with metallocene under constant agitation and heat. Controlled amounts of hydrogen gas are then fed to the mixture to halt polymerization. In general, the amount of hydrogen gas fed to the reactor determines the melt index of the resulting polymer. As used herein, “melt index” or “MI” refers to a measure of the viscosity of the polymer at a given set of conditions. As applied to the materials herein, the MI is expressed as the weight (or mass) of material that flows from a capillary of known dimensions under a specified load or shear rate for a measured period of time and is measured in grams/10 minutes at 190° C. and a load of 2160 grams according to, for example, ASTM test 1238.

In general, the amorphous polyolefin plastomer wax which may be blended with the elastomeric block copolymers in the thermoplastic elastic formulation will be an amorphous polyolefin plastomer wax which, when blended with the block copolymer and subjected to an appropriate combination of pressure and temperature conditions forms an extrudable thermoplastic formulation. For example, suitable amorphous polyolefin wax materials may include polyethylene, polypropylene and polybutene, including ethylene copolymers, propylene copolymers and butene copolymers. In addition, blends of two or more polyolefin waxes may be utilized.

In general, the amorphous polyolefin plastomer wax may be added to the thermoplastic elastic formulation in an amount of up to about 50% by weight. Beyond that amount, the presence of the amorphous polyolefin plastomer wax may begin to interfere with the elastic properties of the formed elastic web. In one embodiment, the thermoplastic elastic formulation may be between about 20% and about 40% by weight amorphous polyolefin wax. For example, in one embodiment, the formulation may include from about 60 wt % to about 95 wt % block copolymer and from about 5 wt % to about 40 wt % amorphous polyolefin wax. Alternatively, the blend may include from about 70 wt % to about 90 wt % elastomeric block copolymer and from about 10 wt % to about 30 wt % amorphous polyolefin wax.

In one embodiment, a suitable amorphous polyolefin plastomer wax may be obtained from The Dow Chemical Company of Midland, Mich., under the trade designation AFFINITY® GA 1900. In another embodiment, a suitable amorphous polyolefin plastomer wax may be utilized which may be obtained from The Dow Chemical Company under the trade designation AFFINITY® GA 1950.

According to The Dow Chemical Company, AFFINITY® 1900 amorphous polyolefin plastomer wax is a low crystallinity, low-density polyolefin for application in the past in the areas of polymer modification, masterbatch/additive carrier, and hot melt adhesives. AFFINITY® 1900 amorphous polyolefin plastomer wax has the following nominal values:
a Brookfield Viscosity at 177° C. of 8200 cP when measured in accordance with ASTM D 1084
a density of 0.870 g/cc when measured in accordance with ASTM D 792
a Melt index of 1,000 grams per ten minutes when measured at 190° C. under a load of 2.16 kg force
a tensile strength of 225 pounds per square inch when measured in accordance with ASTM D 638
a crystallinity of 15.8 calculated as (Heat of Fusion in J/g)/(292 J/g)·100
an elongation of 106% when measured in accordance with ASTM D 638

According to The Dow Chemical Company, AFFINITY® 1950 amorphous polyolefin plastomer wax is a low crystallinity, low-density polyolefin for application in the past in the areas of polymer modification, masterbatch/additive carrier, and hot melt adhesives. AFFINITY® 1900 amorphous polyolefin plastomer wax has the following nominal values:
a Brookfield Viscosity at 177° C. of 17,000 cP when measured in accordance with ASTM D 1084
a density of 0.874 g/cc when measured in accordance with ASTM D 792
a Melt index of 500 grams per ten minutes when measured at 190° C. under a load of 2.16 kg force
a tensile strength of 255 pounds per square inch when measured in accordance with ASTM D 638
a crystallinity of 18.3 calculated as (Heat of Fusion in J/g)/(292 J/g)·100
an elongation of 185% when measured in accordance with ASTM D 638

The thermoplastic elastomeric formulation used in the present invention may contain, in addition to the elastomeric block copolymers and an amorphous polyolefin plastomer wax, plasticizers, pigments, antioxidants and other conventionally employed additives. Optionally, the thermoplastic elastic formulation used in the invention may include the addition of a tackifier.

Tackifiers are generally hydrocarbon resins, wood resins, rosins, rosin derivatives, and the like which have been used in elastomeric formulations in the past to decrease the viscosity of the elastomeric formulation at processing conditions, due to miscibility of the tackifier with the elastomer at use conditions. The tackifiers have been utilized as well to provide tacky elastomeric fibers and/or filaments that autogenously bond and thus tackifiers improved bondability of the product web in a laminate construction. Known tackifiers include hydrocarbon resins, rosin and rosin derivatives, polyterpenes and other similar materials. One such known tackifier is WINGTACK 10, a synthetic polyterpene resin that is liquid at room temperature, and sold by the Goodyear Tire and Rubber Company of Akron, Ohio. WINGTACK 95 is a synthetic tackifier resin also available from Goodyear that comprises predominantly a polymer derived from piperylene and isoprene. Other known tackifying additives utilized in the past include ESCOREZ 1310, an aliphatic hydrocarbon resin, and ESCOREZ 2596, a C₅-C₉ (aromatic modified aliphatic) resin, both manufactured by ExxonMobil Chemical of Houston, Tex. Other tackifiers used in elastomeric formulations in the past include hydrogenated hydrocarbon resins such as REGALREZ™ hydrocarbon resins available from Eastman Chemical Company of Kingsport, Tenn. Terpene hydrocarbons have also been used in the past as tackifiers in elastomeric formulations including, for example, ZONATAK™ 501 lite.

It has been discovered that the addition of such tackifiers to an elastic formulation, while improving bondability and processability of the elastomeric formulation by lowering viscosity of the formulation, can have a detrimental effect on the elastic properties of the elastic web produced from the formulation, and as such, is to be avoided in certain embodiments of the present invention. More specifically, it is believed that the presence of tackifiers in the elastic formulations may reduce the modulus of the elastic materials due to interference of the tackifier with the hard segment of the block copolymer at use conditions. In addition, the use of tackifier in the elastic formulation may result in tackifier buildup on the process equipment and lead to down time of the process line for cleaning.

The thermoplastic elastic formulation of the present invention may be used to form elastic webs characterized by lower modulus values. This decrease in modulus is a result of addition of an amorphous polyolefin plastomer wax, which may decrease the modulus of an elastic web. The addition of the amorphous polyolefin plastomer wax, therefore, presents an opportunity to utilize higher modulus and/or tension, better performing elastomers, and still obtain the same modulus and/or tension as similar formulations not containing the amorphous polyolefin plastomer wax.

The thermoplastic elastic formulation of the present invention may be utilized to form any type of elastic web. For example, the formulation may be utilized to form meltblown, continuous filament, or spunbond elastic webs or elastic films or elastic foams.

In forming an elastic film, the components of the thermoplastic elastic formulation may be mixed together, heated and then extruded at suitable pressure and temperature using any one of a variety of film-producing processes known to those of ordinary skill in the film art including, for example, casting and blowing.

In another embodiment, the thermoplastic elastic formulation may be utilized to form an elastic fibrous nonwoven web. For example, the elastic formulation may be extruded to form meltblown or spunbond fibers and/or continuous filaments so as to produce a meltblown or a spunbond nonwoven elastic web. Continuous filaments may desirably be oriented in parallel fashion to provide stretch in a particular direction, generally the machine direction, of the elastic web. In addition, in one embodiment, the elastic fibrous nonwoven web may be a coform web including elastic fibers according to the present invention combined with other discrete material to form a composite elastomeric nonwoven web.

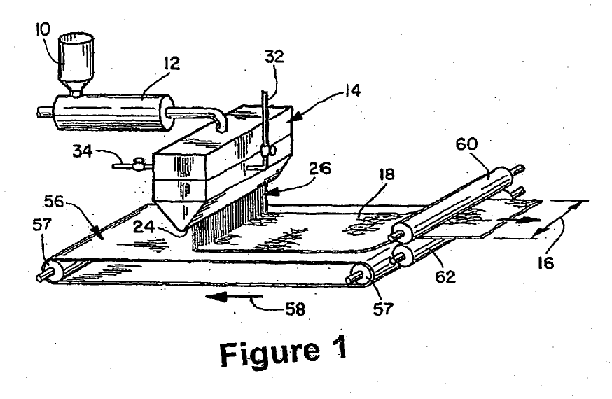

Referring to FIG. 1, which schematically illustrates one embodiment of an apparatus for forming an elastomeric meltblown nonwoven web in accordance with the present invention, it can be seen that the thermoplastic elastic formulation of the present invention (not shown) may be supplied to a hopper 10 of an extruder 12. The components of the formulation may be supplied in pellet or any other suitable form.

The temperature of the formulation is elevated within the extruder 12 by a conventional heating arrangement (not shown) to melt and/or soften the formulation, and pressure is applied to the formulation by the pressure-applying action of a turning screw (not shown), located within the extruder, to form the formulation into an extrudable composition. Desirably the formulation is heated to a temperature of at least about 125° C. if the amorphous polyolefin plastomer wax in the formulation comprises polyethylene or at least about 175° C. if the amorphous polyolefin plastomer wax in the formulation comprises polypropylene. For example, the formulation may be heated in the extruder 12 to a temperature of from at least about 190° C. to about 300° C., more specifically, to a temperature of from at least about 200° C. to about 275° C.

The extrudable composition is then forwarded by the pressure applying action of the turning screw to a meltblowing die 14. The elevated temperature of the extrudable composition is maintained in the meltblowing die 14 by a conventional heating arrangement (not shown). The die 14 generally extends a width which is about equal to the width 16 of the nonwoven web 18 which is to be formed by the process. The combination of temperature and pressure conditions which effect extrusion of the composition will vary over wide ranges. For example, at higher temperatures, lower relative pressures will result in satisfactory extrusion rates and, at higher pressures of extrusion, lower temperatures will affect satisfactory extrusion rates.

The extrudable composition then passes through a plurality of small diameter capillaries (not shown), which exit the die 14 in a linear arrangement, extending across the tip 24 of the die 14, to emerge from the capillaries as molten threads 26. Desirably, the extrudable composition is extrudable, within the above-defined temperature ranges, through the small diameter capillaries at pressures, as applied by the turning screw of the extruder 12, of no more than about 300 psig. For example, in one embodiment, the extrudable composition may be extruded at a pressure of from about 20 psig to about 250 psig. In one embodiment, the composition may be extruded at a pressure of from about 50 psig to about 250 psig.

Generally speaking, the extrudable composition may be extruded through the capillaries 22 of the die 14 at a rate of from at least about 0.02 gram per capillary per minute to about 1.7 or more grams per capillary per minute, for example, from at least about 0.1 gram per capillary per minute to about 1.25 grams per capillary per minute, more specifically, from at least about 0.3 gram per capillary per minute to about 1.1 grams per capillary per minute.

The die 14 is provided with heated, pressurized attenuating gas (not shown) by attenuating gas sources 32 and 34. The heated, pressurized attenuating gas contacts the extruded threads 26 as they exit the die 14. The temperature and pressure of the heated stream of attenuating gas can vary widely. For example, the heated attenuating gas can be applied at a temperature of from about 100° C. to about 400° C., in one embodiment from about 200° C. to about 350° C. The heated attenuating gas can be applied at a pressure of from about 0.5 psig to about 20 psig, more specifically from about 1 psig to about 10 psig.

Referring still to FIG. 1, the two streams of attenuating gas converge to form a stream of gas which entrains and attenuates the molten threads 26, as they exit the linearly arranged capillaries 22, into fibers or, depending upon the degree of attenuation, microfibers (also designated 26) of a small diameter, to a diameter less than the diameter of the capillaries 22. Generally speaking, the attenuating gas may be applied to the molten threads 26 at a temperature of from at least about 100° C. to about 400° C. In one embodiment, from at least about 200° C. to about 350° C. and at pressures of from at least about 0.5 psig to about 20 psig or more. The gas-borne fibers 26 are blown, by the action of the attenuating gas, onto a collecting arrangement which, in the embodiment illustrated in FIG. 1, is a foraminous endless belt 56 conventionally driven by rollers 57.

In one embodiment, the substantially continuous fibers 26 may be formed and deposited on the surface of the belt 56. However, in alternative embodiments, the fibers 26 can be formed in a substantially discontinuous fashion by varying the velocity of the attenuating gas, the temperature of the attenuating gas and the volume of attenuating gas passing through the air passageways in a given time period. Other foraminous arrangements such as an endless belt arrangement may alternatively be utilized.

The belt 56 illustrated in FIG. 1 may also include one or more vacuum boxes (not shown) located below the surface of the foraminous belt 56 and between the rollers 57. In this embodiment, the fibers 26 are collected as a fibrous nonwoven elastomeric web 18 on the surface of the belt 56 which is rotating as indicated by the arrow 58 in FIG. 1. The vacuum boxes assist in retention of the fibers 26 on the surface of the belt 56. Typically the tip 24 of the die tip portion 52 of the meltblowing die 14 is from about 4 inches to about 24 inches from the surface of the foraminous endless belt 56 upon which the fibers 26 are collected. The deposited fibers 26 may then form a coherent, i.e. cohesive, fibrous nonwoven elastomeric web 18 which may be removed from the foraminous endless belt 56 by a pair of pinch rollers 60 and 62 which may be designed to press the entangled fibers of the web 18 together to improve the integrity of the web 18.

In one embodiment, the nonwoven web of the present invention can be a composite material such as, in one embodiment, a coform web which may include fibers and/or filaments formed from the thermoplastic elastic formulation of the present invention as well as discrete particles of one or more solid materials incorporated with the extruded threads 26 prior to their collection as a nonwoven elastomeric web 18. For example, it may be desirable to incorporate one or more secondary fibers such as cotton fibers, wood pulp fibers, polyester fibers or other types of fibers or particulates into the threads 26. Blends of two or more of such fibers or particulates can also be incorporated. This may be accomplished by utilization of a coforming apparatus. Several types of coforming arrangements are well-known to those in the art. Coform processes are shown in U.S. Pat. No. 4,818,464 to Lau and U.S. Pat. No. 4,100,324 to Anderson et al., each incorporated by reference herein in its entirety.

Depending on the characteristics desired of the coformed fibrous nonwoven elastomeric web, the web may include from at least about 20%, by weight, of the elastic material of the present invention. Additionally, the secondary fibers can form from about 30%, by weight, to about 70%, by weight, of the coformed web. In one embodiment, the secondary fibers can form from about 50%, by weight, to about 70%, by weight, of the coformed web.

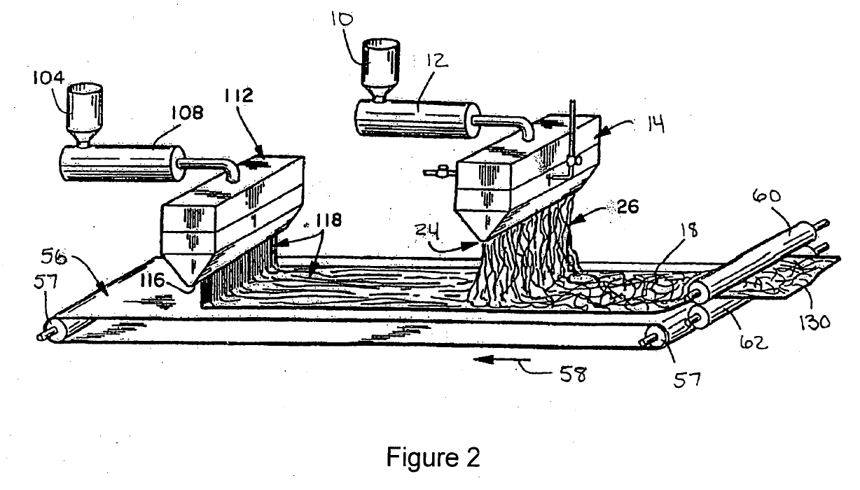

In another embodiment, the elastic web of the present invention may be a multi-layer web. FIG. 2 is a schematic view of a process for forming an anisotropic, multi-layer elastic fibrous web which may be used as a component of a composite elastic material. In forming the fibers and the filaments which are used in the anisotropic elastic fibrous web, pellets or chips, etc. (not shown) of an extrudable elastomeric polymer are introduced into a pellet hoppers 10 and 104 of extruders 12 and 108.

Each extruder has an extrusion screw (not shown) which is driven by a conventional drive motor (not shown). As the polymer advances through the extruder, due to rotation of the extrusion screw by the drive motor, it is progressively heated to a molten state. Heating the polymer to the molten state may be accomplished in a plurality of discrete steps with its temperature being gradually elevated as it advances through discrete heating zones of the extruder 12 toward a meltblowing die 14 (similar to that illustrated in FIG. 1) and extruder 108 toward a continuous filament forming means 112. The meltblowing die 14 and the continuous filament forming means 112 may be yet another heating zone where the temperature of the thermoplastic resin is maintained at an elevated level for extrusion. Heating of the various zones of the extruders 12 and 108 and the meltblowing die 14 and the continuous filament forming means 112 may be achieved by any of a variety of conventional heating arrangements (not shown).

The elastomeric filament component of the anisotropic elastic fibrous web may be formed utilizing a variety of extrusion techniques. For example, the elastic filaments may be formed utilizing one or more conventional meltblowing die arrangements which have been modified to remove the heated gas stream (i.e., the primary air stream) which flows generally in the same direction as that of the extruded threads to attenuate the extruded threads. This modified meltblowing die arrangement 112 usually extends across a foraminous collecting belt 56 in a direction which is substantially transverse to the direction of movement of the collecting surface 56. The modified die arrangement 112 includes a linear array 116 of small diameter capillaries aligned along the transverse extent of the die with the transverse extent of the die being approximately as long as the desired width of the parallel rows of elastomeric filaments which is to be produced. That is, the transverse dimension of the die is the dimension which is defined by the linear array of die capillaries. Typically, the diameter of the capillaries will be on the order of from about 0.01 inches to about 0.02 inches, for example, from about 0.0145 to about 0.018 inches. From about 5 to about 50 such capillaries will be provided per linear inch of die face. Typically, the length of the capillaries will be from about 0.05 inches to about 0.20 inches, for example, about 0.113 inches to about 0.14 inches long. A meltblowing die can extend from about 20 inches to about 60 or more inches in length in the transverse direction.

Since the heated gas stream (i.e., the primary air stream) which flows past the die tip is greatly reduced or absent, it is desirable to insulate the die tip or provide heating elements to ensure that the extruded polymer remains molten and flowable while in the die tip. Polymer is extruded from the array 116 of capillaries in the modified die 112 to create extruded elastomeric filaments 118.

The extruded elastomeric filaments 118 have an initial velocity as they leave the array 116 of capillaries in the modified die 112. These filaments 118 are deposited upon a foraminous surface 56 which should be moving at least at the same velocity as the initial velocity of the elastic filaments 118. This foraminous surface 56 is an endless belt conventionally driven by rollers 57. The filaments 118 are deposited in substantially parallel alignment on the surface of the endless belt 56 which is rotating as indicated by the arrow 58. Vacuum boxes (not shown) may be used to assist in retention of the matrix on the surface of the belt 56. The tip of the die 112 is should be as close as practical to the surface of the foraminous belt 56 upon which the continuous elastic filaments 118 are collected. For example, this forming distance may be from about 2 inches to about 10 inches. Desirably, this distance is from about 2 inches to about 8 inches.

It may be desirable to have the foraminous surface 56 moving at a speed that is much greater than the initial velocity of the elastic filaments 118 in order to enhance the alignment of the filaments 118 into substantially parallel rows and/or elongate the filaments 118 so they achieve a desired diameter. For example, alignment of the elastomeric filaments 118 may be enhanced by having the foraminous surface 56 move at a velocity from about 2 to about 10 times greater than the initial velocity of the elastomeric filaments 118. Even greater speed differentials may be used if desired. While different factors will affect the particular choice of velocity for the foraminous surface 56, it will typically be from about four to about eight times faster than the initial velocity of the elastomeric filaments 118.

Desirably, the continuous elastomeric filaments are formed at a density per inch of width of material which corresponds generally to the density of capillaries on the die face. For example, the filament density per inch of width of material may range from about 10 to about 120 such filaments per inch width of material. Typically, lower densities of filaments (e.g., 10-35 filaments per inch of width) may be achieved with only one filament forming die. Higher densities (e.g., 35-120 filaments per inch of width) may be achieved with multiple banks of filament forming equipment.

A meltblown fiber component 18 of the anisotropic web may then be formed and deposited on the elastomeric filaments 118 in a manner similar to that described by FIG. 1, above. The product anisotropic web, 130, may contain at least about 20% by weight elastomeric filaments. In one embodiment, the anisotropic web 130, may contain from about 20% to about 80% by weight elastomeric filaments.

The elastic webs of the present invention may have a basis weight ranging from about 5 grams per square meter to about 200 grams per square meter while displaying excellent elastic characteristics. In one embodiment, the elastic webs or films of the present invention may have a basis weight ranging from about 5 grams per square meter to about 100 grams per square meter, for example, less than about 16 grams per square meter. In one embodiment, the elastic webs or films of the present invention may have a basis weight of less than about 12 grams per square meter. In one embodiment, the elastic webs or films may display a tension of at least about 450 grams force at an elongation of 50% greater than the non-elongated length of the web.

In one embodiment, the present invention is directed to composite laminate structures including at least one layer of the elastic webs herein disclosed. In general, the individual layers of the composite laminate structures of the present invention may be adhesively bonded one to another. For example, the layers of the laminate structure may be adhesively bonded by use of a spray adhesive with sufficient bonding strength to form an elastic laminate structure which may be stretched and relaxed to provide the desired degree of elasticity. The composite laminate elastic materials of the present invention may be either stretch-bonded laminate materials or neck-bonded laminate materials.

The web or webs to which one or more of the elastic webs are bonded may themselves be elastic or, more usually, may comprise one or more non-elastic webs. Generally, elastic materials such as elastic fibrous webs have a rubbery feel and in applications where the feel of the composite material is of importance, a non-elastic web such as a bonded carded nonelastic polyester or nonelastic polypropylene fiber web, a spunbonded nonelastic polyester or polypropylene nonelastic fiber web, nonelastic cellulosic fiber webs, e.g., cotton fiber webs, polyamide fiber webs, e.g., nylon 6-6 webs, and blends of two or more of the foregoing may be utilized. Generally, woven and nonwoven webs of any textile or other material suitable for the purpose may be used. However, relatively inexpensive and attractive composite fabrics with good hand and feel and with good stretchability and recovery characteristics have been attained by bonding to one or both sides of an elastic web (such as a fibrous elastic web) a bonded carded polyester web, a spunbonded polypropylene fiber web, and single and multi-layer combinations thereof.

In certain embodiments of the present invention the individual layers of the present invention can display improved compatibility toward each other. More specifically, it is believed that the amorphous polyolefin plastomer wax utilized in the elastic formulation, in addition to decreasing the hysteresis behavior of the elastic web, may also improve the compatibility of the elastic material to other polyolefin-based materials, such as nonwoven polyolefin facing materials, for example, when forming composite elastic laminates.

The compatibility between adjacent layers of the composite laminate material can be examined via the differences in solubility parameters of the materials forming the layers. As such, in those embodiments wherein both the elastic web and the adjacent web of the laminate include the same polyolefin, the adjacent layers may be more compatible with each other and display improved bonding as compared to when the adjacent layers contain different materials, e.g., when the elastic laminate includes an elastic web comprising an amorphous polyethylene wax and the adjacent layer of the laminate is a nonwoven polypropylene web. Hence, if a nonwoven facing is based on polyethylene, the amorphous polyolefin plastomer wax of choice for the thermoplastic elastomeric formulation may be an amorphous polyethylene.

In one embodiment of the present invention, the elastic web may be laminated to a nonwoven web which contains both polyethylene and polypropylene. For example, the elastic web may be combined with a nonwoven web formed of copolymerized polyethylene and polypropylene, bicomponent polyethylene/polypropylene fibers, such as side by side bicomponent fibers, or a coform nonwoven web comprising both polyethylene fibers and polypropylene fibers. In such an embodiment, both an amorphous polyethylene wax and an amorphous polypropylene wax may be included in the elastomeric formulation, so as to further improve compatibility between the adjacent layers in the bonded laminate.

In one embodiment, the composite elastic laminate structures of the present invention may be either neck-bonded or stretch-bonded laminate materials. As used herein, the term “neck-bonded” refers to an elastic member being bonded to a non-elastic member while the non-elastic member is extended in the machine direction creating a necked material. “Neck-bonded laminate” refers to a composite material having at least two layers in which one layer is a necked, non-elastic layer and the other layer is an elastic layer thereby creating a material that is elastic in the cross direction. Examples of neck-bonded laminates are such as those described in U.S. Pat. Nos. 5,226,992, 4,981,747, 4,965,122, and 5,336,545, all to Morman, which are incorporated herein by reference thereto as to all relevant material.

As used herein, the term “stretch-bonded” refers to a composite material having at least two layers in which one layer is a gatherable layer and the other layer is an elastic layer. The layers are joined together when the elastic layer is in an extended condition so that upon relaxing the layers, the gatherable layer is gathered. For example, one elastic member can be bonded to another member while the elastic member is extended at least about 25 percent of its relaxed length. The resultant composite laminate material may then itself be elastic, since its non-elastic layers will be able to move with the stretching of the elastic layer by reason of the play or give provided by the gathers formed in the non-elastic layers during the bonding of the layers. One type of stretch-bonded laminate is disclosed, for example, in U.S. Pat. No. 4,720,415 to Vander Wielen et al., which is incorporated herein by reference as to all relevant material. Another type of stretch-bonded laminate, apparatus and process of making thereof is disclosed, for example, in U.S. Patent Application Publication 2002/0104608A1 to Welch et al., which is incorporated herein by reference as to all relevant material. Advantageously, the low hysteresis stretch-bonded laminates of the present invention are more easily wound in roll form than laminates exhibiting higher levels of hysteresis. Without intending to be bound by any particular theory, it is believed that the low hysteresis stretch-bonded laminates of the present invention better maintain tension levels during the winding process, thus preventing weaving that may occur when the winding tension is not maintained.

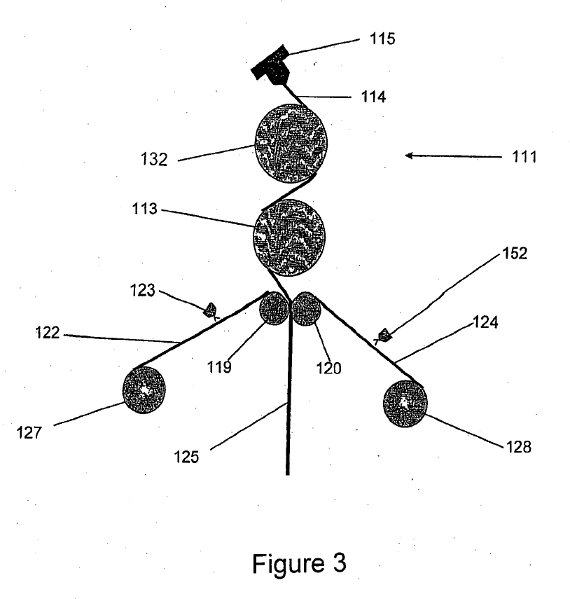

In FIG. 3, an exemplary vertically arranged apparatus 111 for making stretch bonded laminates is depicted. An extruder 115 is mounted for extruding continuous molten filaments 114 downward from a die 115 at a canted angle onto a chilled positioning roller 132. The chilled positioning roller 132 ensures proper alignment through the remainder of the system as it spreads the filaments. As the filaments travel over the surface of the chilled positioning roller 132, they are cooled and solidified as they travel towards and over the chilled surface of a second chilled roller 113. As in other embodiments, the filaments then travel downward toward a laminator section of the system comprising a nip formed by a first nip roller 119 and a second nip roller 120. The continuous filaments in this embodiment may also be combined at the nip with various types of gatherable facings. In the embodiment depicted in FIG. 3, a first non-woven spunbond facing 122 and a second non-woven spunbond facing 124 are combined on opposing surfaces of the continuous filaments to form a bonded laminate 125. The spunbond facings 122, 124 are provided to the nip by a first outer facing roll 127 and a second outer facing roll 128. Bonding of the facings to the continuous filaments is accomplished in this embodiment by the use of two spray-type adhesive applicators. A spray head 123 delivers adhesive to the surface of at least one of the non-woven spunbond facings 122 prior to compression and lamination at the nip; and a second spray head 152 applies adhesive to the other non-woven spunbond facing 124.

The layers of the composite laminate structures of the present invention may be adhesively bonded together without the addition of heat. The use of adhesive bonding is generally desired in the laminate structure in order to prevent stretching, thinning, or other damage to the individual layers. Such damage may lead to areas of weakness in the laminate and possible breaks or ruptures forming in the laminate materials under expected use conditions.

Any suitable adhesives which do not require elevated temperatures in order to form a bond may be utilized in the present invention. For example, in one embodiment, spray adhesives such as 2525A or 2096, both available from Bostik, Inc. of Huntingdon Valley, Pa. may be used.

Latex materials may also serve as the adhesive joining two layers in the laminate structure of the present invention. Examples of latex adhesives include latex 8085 from Bostik Inc. The latex may be any latex, synthetic latex (e.g., a cationic or anionic latex), or natural latex or derivatives thereof.

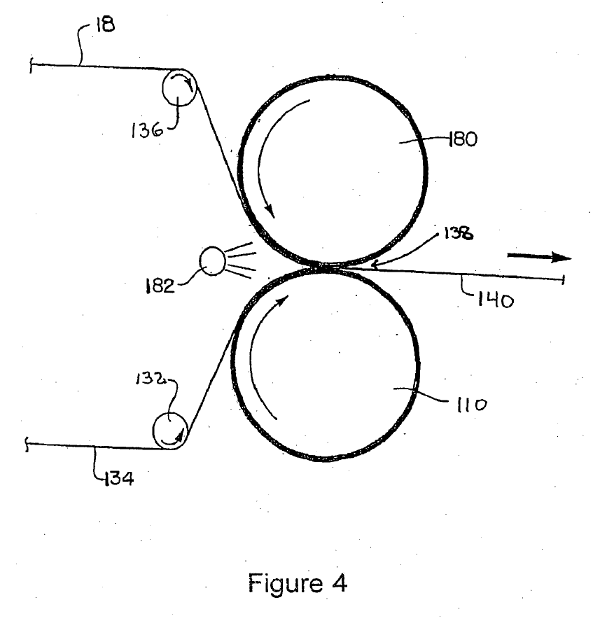

The layers of the laminate composite material may be adhesively bonded in any suitable fashion. For example, one possible embodiment for a method of adhesively bonding an elastic web with another layer to form an elastic composite laminate is illustrated in FIG. 4. As can be seen in the figure, an elastic web 18 and a second web 134 may be brought together after formation by use of guide rolls 132 and 136, and an adhesive 182 may be applied to one or both layers prior to or at contact between the layers which may bond the layers of the laminate material together. For example, the layers may be brought together in a nip 138, between rolls 110 and 180 to form an adhesively bonded laminate construction 140. In this embodiment, the layers may be attached through utilization of the adhesive alone, or optionally, pressure may also be applied in the nip 132 as the layers are brought together, to further enhance the bond between the layers. An adhesive may be applied to one or both of the layers of the laminate material by any method. For example, in addition to a spray method, as illustrated in FIG. 4, an adhesive may be applied through any known printing, coating, or other suitable transfer method. In one embodiment, the basis weight of the adhesive may be about 1 gsm or greater, such as from about 2 gsm to about 50 gsm, more specifically about 2 gsm to about 10 gsm. Alternatively, the basis weight of the added adhesive may be less than about 5 gsm.

The laminate structures of the present invention may include 2, 3, 4 or even more individual layers. For example, the laminate structure may include a single elastic web sandwiched between two other non-elastic facing layers. In another embodiment, the laminate material may include an elastic film which may serve as an outer layer of a laminate structure and one or more additional layers (which may include additional elastic webs) bonded to one side of the elastic film. Any other combination of webs in a laminate structure is encompassed by the present invention.

The laminate structures of the present invention may be utilized generally in any article calling for elastic materials. For example, the laminate structure may be converted and included in many different products, such as various personal care products. Products which may utilize the novel laminate structures may include, for example, stretchable protective covers and wraps, outerwear, undergarments, feminine hygiene pads, incontinence control pads, and disposable garments including incontinence garments, disposable diapers, training pants, and the like.

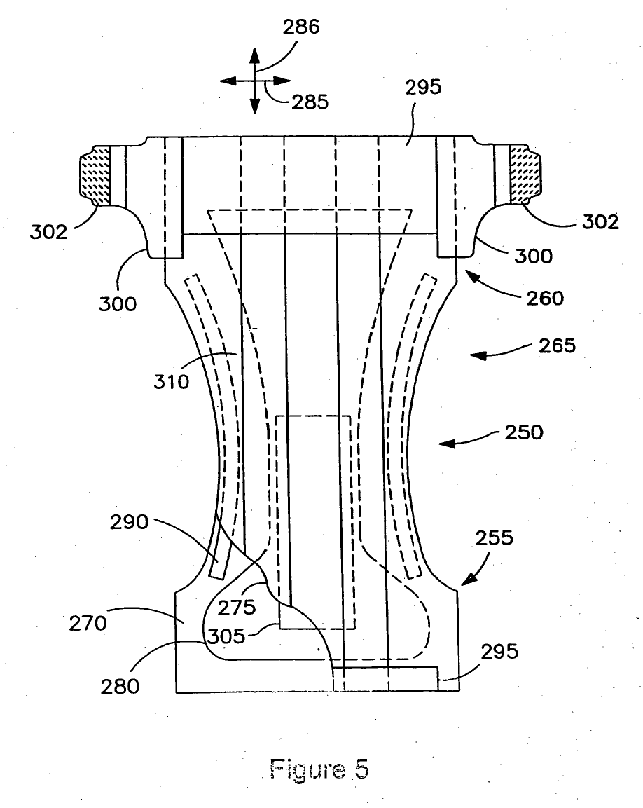

Such laminate materials may be useful in providing elastic waist, leg cuff/gasketing, stretchable ear, side panel or stretchable outer cover applications. While not intending to be limiting, FIG. 5 is presented to illustrate the various components of a personal care product, such as a diaper, that may take advantage of such elastic laminate materials. Other examples of personal care products that may incorporate such materials are training pants (such as in side panel materials) and feminine care products. By way of illustration only, training pants suitable for use with the present invention and various materials and methods for constructing the training pants are disclosed in U.S. Pat. No. 6,761,711 to Fletcher et al.; U.S. Pat. No. 4,940,464 Van Gompel et al.; U.S. Pat. No. 5,766,389 to Brandon et al.; and U.S. Pat. No. 6,645,190 to Olson et al., which are each incorporated herein by reference in its entirety.

With reference to FIG. 5, a disposable diaper 250 generally defines a front waist section 255, a rear waist section 260, and an intermediate section 265 which interconnects the front and rear waist sections. The front and rear waist sections 255 and 260 include the general portions of the diaper which are constructed to extend substantially over the wearer's front and rear abdominal regions, respectively, during use. The intermediate section 265 of the diaper includes the general portion of the diaper that is constructed to extend through the wearer's crotch region between the legs. Thus, the intermediate section 265 is an area where repeated liquid surges typically occur in the diaper.

The diaper 250 includes, without limitation, an outer cover, or backsheet 270, a liquid permeable bodyside liner, or topsheet, 275 positioned in facing relation with the backsheet 270, and an absorbent core body, or liquid retention structure, 280, such as an absorbent pad, which is located between the backsheet 270 and the topsheet 275. The backsheet 270 defines a length, or longitudinal direction 286, and a width, or lateral direction 285 which, in the illustrated embodiment, coincide with the length and width of the diaper 250. The liquid retention structure 280 generally has a length and width that are less than the length and width of the backsheet 270, respectively. Thus, marginal portions of the diaper 250, such as marginal sections of the backsheet 270 may extend past the terminal edges of the liquid retention structure 280. In the illustrated embodiments, for example, the backsheet 270 extends outwardly beyond the terminal marginal edges of the liquid retention structure 280 to form side margins and end margins of the diaper 250. The topsheet 275 is generally coextensive with the backsheet 270 but may optionally cover an area which is larger or smaller than the area of the backsheet 270, as desired.

To provide improved fit and to help reduce leakage of body exudates from the diaper 250, the diaper side margins and end margins may be elasticized with suitable elastic members, as further explained below. For example, as representatively illustrated in FIG. 5, the diaper 250 may include leg elastics 290 which are constructed to operably tension the side margins of the diaper 250 to provide elasticized leg bands which can closely fit around the legs of the wearer to reduce leakage and provide improved comfort and appearance. Waist elastics 295 are employed to elasticize the end margins of the diaper 250 to provide elasticized waistbands. The waist elastics 295 are configured to provide a resilient, comfortably close fit around the waist of the wearer.

The elastic stretch bonded laminate materials of the inventive structure are suitable for use as the leg elastics 290 and waist elastics 295. Exemplary of such materials are laminate sheets which either comprise or are adhered to the backsheet, such that elastic constrictive forces are imparted to the backsheet 270.

As is known, fastening means, such as hook and loop fasteners, may be employed to secure the diaper 250 on a wearer. Alternatively, other fastening means, such as buttons, pins, snaps, adhesive tape fasteners, cohesives, fabric-and-loop fasteners, or the like, may be employed. In the illustrated embodiment, the diaper 250 includes a pair of side panels 300 (or ears) to which the fasteners 302, indicated as the hook portion of a hook and loop fastener, are attached. Generally, the side panels 300 are attached to the side edges of the diaper in one of the waist sections 255, 260 and extend laterally outward therefrom. The side panels 300 may be elasticized or otherwise rendered elastomeric by use of a stretch bonded laminate material made from the inventive structure. Examples of absorbent articles that include elasticized side panels and selectively configured fastener tabs are described in PCT Patent Application WO 95/16425 to Roessler; U.S. Pat. No. 5,399,219 to Roessler et al.; U.S. Pat. No. 5,540,796 to Fries; and U.S. Pat. No. 5,595,618 to Fries each of which is hereby incorporated by reference in its entirety.

The diaper 250 may also include a surge management layer 305, located between the topsheet 275 and the liquid retention structure 280, to rapidly accept fluid exudates and distribute the fluid exudates to the liquid retention structure 280 within the diaper 250. The diaper 250 may further include a ventilation layer (not illustrated), also called a spacer, or spacer layer, located between the liquid retention structure 280 and the backsheet 270 to insulate the backsheet 270 from the liquid retention structure 280 to reduce the dampness of the garment at the exterior surface of a breathable outer cover, or backsheet, 270. Examples of suitable surge management layers 305 are described in U.S. Pat. No. 5,486,166 to Bishop and U.S. Pat. No. 5,490,846 to Ellis.

As representatively illustrated in FIG. 5, the disposable diaper 250 may also include a pair of containment flaps 310 which are configured to provide a barrier to the lateral flow of body exudates. The containment flaps 310 may be located along the laterally opposed side edges of the diaper adjacent the side edges of the liquid retention structure 280. Each containment flap 310 typically defines an unattached edge which is configured to maintain an upright, perpendicular configuration in at least the intermediate section 265 of the diaper 250 to form a seal against the wearer's body. The containment flaps 310 may extend longitudinally along the entire length of the liquid retention structure 280 or may only extend partially along the length of the liquid retention structure. When the containment flaps 310 are shorter in length than the liquid retention structure 280, the containment flaps 310 can be selectively positioned anywhere along the side edges of the diaper 250 in the intermediate section 265. Such containment flaps 310 are generally well known to those skilled in the art. For example, suitable constructions and arrangements for containment flaps 310 are described in U.S. Pat. No. 4,704,116 to K. Enloe.

The diaper 250 may be of various suitable shapes. For example, the diaper may have an overall rectangular shape, T-shape or an approximately hour-glass shape. In the shown embodiment, the diaper 250 has a generally I-shape. Other suitable components which may be incorporated on absorbent articles of the present invention may include waist flaps and the like which are generally known to those skilled in the art. Examples of diaper configurations suitable for use in connection with the elastic stretch bonded laminate materials of the instant invention which may include other components suitable for use on diapers are described in U.S. Pat. No. 4,798,603 to Meyer et al.; U.S. Pat. No. 5,176,668 to Bernardin; U.S. Pat. No. 5,176,672 to Bruemmer et al.; U.S. Pat. No. 5,192,606 to Proxmire et al. and U.S. Pat. No. 5,509,915 to Hanson et al. each of which is hereby incorporated by reference in its entirety.

The various components of the diaper 250 are assembled together employing various types of suitable attachment means, such as adhesive bonding, ultrasonic bonding, thermal point bonding or combinations thereof. In the shown embodiment, for example, the topsheet 275 and backsheet 270 may be assembled to each other and to the liquid retention structure 280 with lines of adhesive, such as a hot melt, pressure-sensitive adhesive. Similarly, other diaper components, such as the elastic members 290 and 295, fastening members 302, and surge layer 305 may be assembled into the article by employing the above-identified attachment mechanisms.

It should be appreciated that such elastic stretch bonded laminate materials may likewise be used in other personal care products, protective outerwear, protective coverings and the like. Further such materials can be used in bandage materials for both human and animal bandaging products. Use of such materials provides the same manufacturing benefits described above.

Reference now will be made to various embodiments of the invention, one or more examples of which are set forth below. Each example is provided by way of explanation of the invention, not as a limitation of the invention. In fact, it will be apparent to those skilled in the art that various modifications and variations may be made of this invention without departing from the scope or spirit of the invention.

### Testing Methods

Load-Elongation Cycle Test

All load-elongation mechanical tests of the samples were performed using a Sintech 1/s frame. The film samples used were cut using a Type I “dog bone” die, specified in ASTM D638 tensile test method. The sample was clamped into the jaws of a Sintech 1/S testing frame, set at a 2″ grip-to-grip distance. The displacement of the crosshead was set at a speed of 20″/min. The film samples were stretched to either about 300% or about 500% at room temperature (about 20° C.) and then allowed to retract. The normalized load and elongation were calculated using knowledge of the initial length, final length, thickness, and width of the film samples. Hysteresis values were calculated as described above using the areas under the extension and retraction curves. The immediate set was calculated as described above from the initial and final lengths of the film samples.

### EXAMPLES

The elastomeric polymers used in these examples were obtained in pellet form or were converted to pellets before conversion. All polymers were composed of triblock styrene-ethylenebutylene-styrene (S-EB-S) backbone structure. The tackifier used was REGALREZ 1126 hydrocarbon resin available from Eastman Chemical.

Films were prepared having elastomeric polymer formulations as shown below in Table 1, which includes an identification number, components present, and the composition of the formulations. Film samples having thickness of about 5 to about 7 mils were produced from each formulation and subjected to cycle testing for determination of elastic properties as shown below in Table 2.

TABLE 1
Film Formulations

| Sample | S-EB-S | Tackifier | |
|---|---|---|---|
| ID | content | content | Wax |
| 1 | 68% | 20% | 12% C-10 |
| 2 | 68% | 20% | 12% AFFINITY ® 1900 |
| 3 | 68% | 20% | 12% AFFINITY ® 1950 |
| 4 | 80% | 13% | 7% AFFINITY ® 1950 |

TABLE 2
Film Properties

| | | |
|---|---|---|
| Sample | Immediate set | Hysteresis |

| ID | 300% | 500% | 300% | 500% |
|---|---|---|---|---|
| 1 | 28% | 58% | 39% | 50% |
| 2 | 18% | 31% | 26% | 34% |
| 3 | 17% | 36% | 27% | 40% |
| 4 | 23% | 39% | 28% | 38% |

FIG. 6 gives a schematic illustration of the normalized load-elongation and retraction behavior of the Example films. Specifically, FIG. 6 illustrates the normalized load as a function of elongation and retraction for Sample ID numbers 1, 2, 3 and 4 as described in Table 1, above. It can be seen from FIG. 6 that the normalized load/tension as a function of elongation of the films containing amorphous waxes (2 and 3) is lower than that of the C-10 wax that is a crystalline wax (1) for those films having the same composition of elastic polymer, tackifier and wax. This provides an opportunity to tune the properties of the elastic polymer, for example to increase the molecular weight of the elastomer molecule, to increase tension and elastic performance. It can also be seen in FIG. 6 and Table 2 that the hysteresis and immediate set for those samples containing the amorphous wax is lower than for the C-10 wax. It is also seen by comparing samples 3 and 4 that increasing the rubber content increases the tension of the film, thus providing another opportunity to improve elastic properties.

It will be appreciated that the foregoing examples, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, yet the absence of a particular advantage shall not be construed to necessarily mean that such an embodiment is outside the scope of the present invention. In addition, it should be noted that any given range presented herein is intended to include any and all lesser included ranges. For example, a range of from 45-90 would also include 50-90; 45-80; 46-89 and the like. Thus, the range of 95% to 99.999% also includes, for example, the ranges of 96% to 99.1%, 96.3% to 99.7%, and 99.91% to 99.999%, etc.

What is claimed:

1. An elastic web comprising:
an elastomeric block copolymer comprising at least one thermoplastic block which comprises a styrenic moiety and at least one elastomeric polymer block selected from the group consisting of conjugated dienes, lower alkene polymers, and saturated equivalents thereof; and
greater than 0% and less than about 50% by weight of an amorphous polyolefin plastomer wax.

2. The elastic web of claim 1, wherein the elastic web has a basis weight less than about 16 grams per square meter.

3. The elastic web of claim 1, wherein the elastic web comprises a fibrous nonwoven elastic web.

4. The elastic web of claim 3, wherein the fibrous nonwoven elastic web comprises a meltblown web.

5. The elastic web of claim 3, wherein the fibrous nonwoven elastic web comprises elastomeric filaments.

6. The elastic web of claim 3, wherein the fibrous nonwoven elastic web comprises a spunbond elastic web.

7. The elastic web of claim 3, wherein the fibrous nonwoven elastic web comprises a coform web.

8. The elastic web of claim 1, wherein the elastic web comprises an extruded elastic film.

9. The elastic web of claim 1, wherein the elastic film exhibits less than about 140 grams-force/mil/inch tension when the elastic film is elongated by about 300% of its non-stretched length.

10. The elastic web of claim 1, wherein the elastomeric block copolymer comprises a diblock copolymer.

11. The elastic web of claim 1, wherein the elastomeric block copolymer comprises a triblock copolymer.

12. The elastic web of claim 11, wherein the triblock copolymer comprises a polystyrene/poly(ethylene-propylene)/polystyrene block copolymer.

13. The elastic web of claim 11, wherein the triblock copolymer comprises a polystyrene/poly(ethylene-butylene)/polystyrene block copolymer.

14. The elastic web of claim 1, wherein the block copolymer comprises a tetrablock copolymer.

15. The elastic web of claim 14, wherein the tetrablock copolymer comprises a polystyrene/polyethylene/poly(ethylene-propylene)/polystyrene block copolymer.

16. The elastic web of claim 14, wherein the tetrablock copolymer comprises a polystyrene/poly(ethylene-propylene)/polystyrene/poly(ethylene-propylene) block copolymer.

17. The elastic web of claim 1, wherein the amorphous polyolefin plastomer wax is selected from the group consisting of polyethylene, polypropylene, polybutene, and mixtures thereof.

18. The elastic web of claim 1, wherein the amorphous polyolefin plastomer wax is selected from the group consisting of an ethylene copolymer, a propylene copolymer, a butene copolymer, and mixtures thereof.

19. The elastic web of claim 1, wherein the elastic web comprises between about 5% and about 40% by weight of the amorphous polyolefin plastomer wax.

20. The elastic web of claim 1, wherein the elastic web is substantially free of a tackifier.

21. The elastic web of claim 20, wherein the elastic web does not contain a tackifier.

22. The elastic web of claim 1, wherein the elastic web exhibits hysteresis in a 300 percent elongation cycle test between about 5 percent to about 35 percent.

23. The elastic web of claim 1, wherein the elastic web exhibits immediate set in a 300 percent elongation cycle test between about 5 percent to about 25 percent.

24. The elastic web of claim 1, wherein the amorphous polyolefin plastomer wax has crystallinity between about 3 percent to about 20 percent.

25. An elastic laminate structure comprising:
an elastic web comprising greater than 0% and less than about 50% by weight of an amorphous polyolefin plastomer wax and an elastomeric block copolymer comprising at least one thermoplastic block which comprises a styrenic moiety and at least one elastomeric polymer block selected from the group consisting of conjugated dienes, lower alkene polymers, and a saturated equivalents thereof; and
a second web adhesively secured to the elastic web.

26. The elastic laminate structure of claim 25, wherein the second web is adhesively secured to the elastic web with a spray adhesive other than a hot melt adhesive.

27. The elastic laminate structure of claim 25, wherein the second web comprises a nonwoven web.

28. The elastic laminate structure of claim 27, wherein the second web comprises a meltblown or spunbond nonwoven web comprising polyolefin fibers.

29. The elastic laminate structure of claim 28, wherein the polyolefin fibers are selected from the group consisting of polyethylene fibers, polypropylene fibers, and mixtures thereof.

30. The elastic laminate structure of claim 28, wherein the polyolefin fibers comprise bicomponent fibers.

31. The elastic laminate structure of claim 28, wherein the polyolefin fibers and the amorphous polyolefin plastomer wax comprise the same polyolefin.

32. The elastic laminate structure of claim 25, wherein the elastic laminate structure is a stretch-bonded laminate.

33. The elastic laminate structure of claim 25, wherein the elastic laminate structure is a neck-bonded laminate.

34. The elastic laminate structure of claim 25, wherein the laminate structure further comprises at least one additional layer.

35. The elastic laminate structure of claim 25, wherein the elastic web exhibits hysteresis in a 300 percent elongation cycle test between about 5 percent to about 35 percent.

36. The elastic laminate structure of claim 25, wherein the elastic web exhibits immediate set in a 300 percent elongation cycle test between about 5 percent to about 25 percent.

37. The elastic laminate structure of claim 25, wherein the amorphous polyolefin plastomer wax has crystallinity between about 3 percent to about 20 percent.

38. A personal care product comprising:
an elastic laminate structure wherein the elastic laminate structure comprises:
(a) an elastic web comprising greater than 0% and less than about 50% by weight of an amorphous polyolefin plastomer wax and an elastomeric block copolymer comprising at least one thermoplastic block which comprises a styrenic moiety and at least one elastomeric polymer block selected from the group consisting of conjugated dienes, lower alkene polymers, and saturated equivalents thereof;
(b) a second nonwoven web; and
(c) a spray adhesive between the elastic web and second web adhesively securing the elastic web and the second web together.

39. The personal care product of claim 38, wherein the personal care product is a disposable garment.

40. The personal care product of claim 38, wherein the disposable garment is selected from the group consisting of an incontinence garment, a disposable diaper, and disposable training pants.

41. The personal care product of claim 38, wherein the personal care product comprises a protective cover.

42. The personal care product of claim 38, wherein the personal care product is a feminine hygiene pad.

43. The personal care product of claim 38, wherein the personal care product is an incontinence control pad.

44. An elastomeric composition comprising:
an elastomeric block copolymer comprising at least one thermoplastic block which comprises a styrenic moiety and at least one elastomeric polymer block selected from the group consisting of conjugated dienes, lower alkene polymers, and saturated equivalents thereof; and
greater than 0% and less than about 50% by weight of an amorphous polyolefin plastomer wax.

45. The elastomeric composition of claim 44, wherein the elastomeric block copolymer comprises a diblock copolymer.

46. The elastomeric composition of claim 44, wherein the elastomeric block copolymer comprises a triblock copolymer.

47. The elastomeric composition of claim 46, wherein the triblock copolymer comprises a polystyrene/poly(ethylene-propylene)/polystyrene block copolymer.

48. The elastomeric composition of claim 46, wherein the triblock copolymer comprises a polystyrene/poly(ethylene-butylene)/polystyrene block copolymer.

49. The elastomeric composition of claim 44, wherein the block copolymer comprises a tetrablock copolymer.

50. The elastomeric composition of claim 49, wherein the tetrablock copolymer comprises a polystyrene/polyethylene/poly(ethylene-propylene)/polystyrene block copolymer.

51. The elastomeric composition of claim 49, wherein the tetrablock copolymer comprises a polystyrene/poly(ethylene-propylene)/polystyrene/poly(ethylene-propylene) block copolymer.

52. The elastomeric composition of claim 44, wherein the amorphous polyolefin plastomer wax is selected from the group consisting of polyethylene, polypropylene, polybutene, and mixtures thereof.

53. The elastomeric composition of claim 44, wherein the amorphous polyolefin plastomer wax is selected from the group consisting of an ethylene copolymer, a propylene copolymer, a butene copolymer, and mixtures thereof.

54. The elastomeric composition of claim 44, wherein the elastomeric composition comprises between about 5% and about 40% by weight of the amorphous polyolefin plastomer wax.

55. The elastomeric composition of claim 44, wherein the elastomeric composition is substantially free of a tackifier.

56. The elastomeric composition of claim 55, wherein the elastomeric composition does not contain a tackifier.

57. The elastomeric composition of claim 44, wherein the amorphous polyolefin plastomer wax has crystallinity between about 3 percent to about 20 percent.
